(19) United States
(12) Patent Application Publication
(10) Pub. No.: US 2025/0380274 A1
(43) Pub. Date: Dec. 11, 2025

(54) PHASE SEQUENCE-BASED PHYSICAL DOWNLINK CONTROL CHANNEL SIGNALING FOR WIRELESS COMMUNICATION

(71) Applicant: Lenovo (United States) Inc., Morrisville, NC (US)

(72) Inventors: Ali Ramadan Ali, Kraiburg am Inn (DE); Karthikeyan Ganesan, Nauheim (DE)

(21) Appl. No.: 19/300,424

(22) Filed: Aug. 14, 2025

(51) Int. Cl. H04W 72/231; H04J 13/00; H04L 1/00; H04L 27/26; H04W 76/20

(52) U.S. Cl. CPC H04W 72/231; H04J 13/0062; H04L 1/0038; H04L 27/2614; H04L 27/2634; H04W 76/20

(57) ABSTRACT

Various aspects relate to methods, apparatuses, and devices for wireless communication. A base station may modify a set of symbols in a frequency domain by applying a phase sequence to each of one or more symbols for a physical downlink control channel (PDCCH). An inverse fast Fourier transform (IFFT) may be performed on the modified set to obtain a set of signals for PDCCH in a time domain. A signal may be selected from the set based on a criterion comprising one or more of a peak-to-average power ratio (PAPR) value satisfying a threshold, or a cubic metric (CM) value satisfying a threshold. The selected signal may be transmitted over PDCCH to a user equipment (UE), where the UE decodes the signal using blind decoding using phase information or signal-based sequence identification.

### TECHNICAL FIELD

The present disclosure relates to wireless communications, and more specifically to managing (e.g., generating, selecting) phase sequence-based physical downlink control channel (PDCCH) in a wireless communications system.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, including in the claims, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Various aspects of the present disclosure relate to wireless communications, including improved base stations, UEs, processors, and methods for generating, selecting, and communicating (e.g., transmitting, receiving) PDCCH using phase sequences. These techniques may reduce peak-to-average power ratio (PAPR) or cubic metric (CM) while maintaining robust control channel performance.

A base station for wireless communication is described. The base station comprises at least one memory and at least one processor coupled with the at least one memory and is configured to cause the base station to modify a set of symbols in a frequency domain based at least in part on applying a phase sequence to each of one or more symbols of the set of symbols for physical downlink control channel (PDCCH), obtain a set of signals for PDCCH in a time domain based at least in part on performing an inverse fast Fourier transform (IFFT) on the modified set of symbols in the frequency domain, select a signal from the set of signals for PDCCH in the time domain based at least in part on a criterion comprising one or more of a peak-to-average power ratio (PAPR) value satisfying a threshold, or cubic metric (CM) value satisfying a threshold, and transmit the selected signal over PDCCH to a user equipment (UE). The selected PDCCH time domain signal may be decodable by the UE using blind decoding using phase information or signal-based sequence identification.

A processor (e.g., a standalone chipset or a component of a base station) for wireless communication is described. The processor is configured to cause the base station to modify a set of symbols in a frequency domain based at least in part on applying a phase sequence to each of one or more symbols of the set of symbols for PDCCH, obtain a set of signals for PDCCH in a time domain based at least in part on performing an IFFT on the modified set of symbols in the frequency domain, select a signal from the set of signals for PDCCH in the time domain based at least in part on a criterion comprising one or more of a PAPR value satisfying a threshold, or a CM value satisfying a threshold, and transmit the selected signal over PDCCH to a UE, wherein the UE is configured to decode the signal using blind decoding using phase information or signal-based sequence identification.

A method performed by a base station for wireless communication is described. The method comprises modifying a set of symbols in a frequency domain based at least in part on applying a phase sequence to each of one or more symbols of the set of symbols for PDCCH, obtaining a set of signals for PDCCH in a time domain based at least in part on performing an IFFT on the modified set of symbols in the frequency domain, selecting a signal from the set of signals for PDCCH in the time domain based at least in part on a criterion comprising one or more of a PAPR value satisfying a threshold, or a CM value satisfying a threshold, and transmitting the selected signal over PDCCH to a UE, wherein the signal is decodable using blind decoding using phase information or signal-based sequence identification.

A UE for wireless communication is described. The UE comprises at least one memory and at least one processor coupled with the at least one memory and is configured to cause the UE to receive a signal over PDCCH selected from a set of signals for PDCCH in a time domain based at least in part on a criterion, wherein the set of signals for PDCCH in the time domain is obtained at least in part by performing an IFFT on a modified set of symbols in a frequency domain, and the modified set of symbols is obtained by applying a phase sequence to each of one or more symbols of a set of symbols in the frequency domain, and decode the signal using blind decoding using phase information or signal-based sequence identification.

A processor (e.g., a standalone chipset or a component of a UE) for wireless communication is described. The processor is configured to cause the UE to receive a signal over PDCCH selected from a set of signals for PDCCH in a time domain based at least in part on a criterion comprising one or more of a PAPR value satisfying a threshold, or a CM value satisfying a threshold, wherein the set of signals for PDCCH in the time domain is obtained at least in part by performing an IFFT on a modified set of symbols in a frequency domain, and the modified set of symbols is obtained by applying a phase sequence to each of one or more symbols of a set of symbols in the frequency domain. The processor may further decode the signal using blind decoding using phase information or signal-based sequence identification.

A method performed by a UE for wireless communication is described. The method comprises receiving a signal over PDCCH selected from a set of signals for PDCCH in a time domain based at least in part on a criterion comprising one or more of a PAPR value satisfying a threshold, or a CM value satisfying a threshold, wherein the set of signals for PDCCH in the time domain is obtained at least in part by performing an IFFT on a modified set of symbols in a frequency domain, and the modified set of symbols is obtained by applying a phase sequence to each of one or more symbols of a set of symbols in the frequency domain, and decoding the signal using blind decoding using phase information or signal-based sequence identification.

### BRIEF DESCRIPTION OF THE DRAWINGS

FIG. 1 illustrates an example of a wireless communications system in accordance with aspects of the present disclosure.

FIG. 2 illustrates an example of selective mapping (SLM)-orthogonal frequency division multiplexing (OFDM) for a physical downlink control channel (PDCCH) with blind search at the UE in accordance with aspects of the present disclosure.

FIG. 3 illustrates an example of SLM-OFDM for the PDCCH with explicit sequence indication using a staged PDCCH structure in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a NE in accordance with aspects of the present disclosure.

FIG. 7 illustrates a flowchart of a method performed by a NE in accordance with aspects of the present disclosure.

FIG. 8 illustrates a flowchart of a method performed by a UE in accordance with aspects of the present disclosure.

### DETAILED DESCRIPTION

A wireless communications system may support wireless communication (e.g., transmission, reception) on a physical downlink control channel (PDCCH) using cyclic-prefix orthogonal frequency division multiplexing (CP-OFDM) with fixed modulation schemes, such as quadrature phase-shift keying (QPSK). A primary consideration for efficient PDCCH transmission in such wireless communication systems may be managing a peak-to-average power ratio (PAPR) and cubic metric (CM) of the CP-OFDM waveform. High PAPR and CM values may degrade power amplifier efficiency, increase power consumption, and reduce link coverage. These impacts may be particularly important for control channels, such as the PDCCH, where robust transmission and reception is essential to ensure reliable scheduling, resource allocation, and the like.

Selective mapping (SLM) techniques may effectively reduce PAPR and CM by generating multiple phase-rotated candidate signals and selecting the candidate having the most favorable characteristics (e.g., lowest PAPR and/or lowest CM). However, applying SLM to a PDCCH may introduce a limitation in that a UE may need to be informed of or know (e.g., identify, determine) the phase sequence selected by an NE in order to correctly demodulate and decode the PDCCH. This requirement may lead to increased signaling overhead or decoding complexity. Various aspects described herein may enable the use of SLM for communication (e.g., transmission, reception) of PDCCH while mitigating such increased overhead signaling and decoding complexity, thereby improving the practicality of SLM for PDCCH transmission and PDCCH reception in wireless communication systems.

Aspects of the present disclosure are described in the context of a wireless communications system.

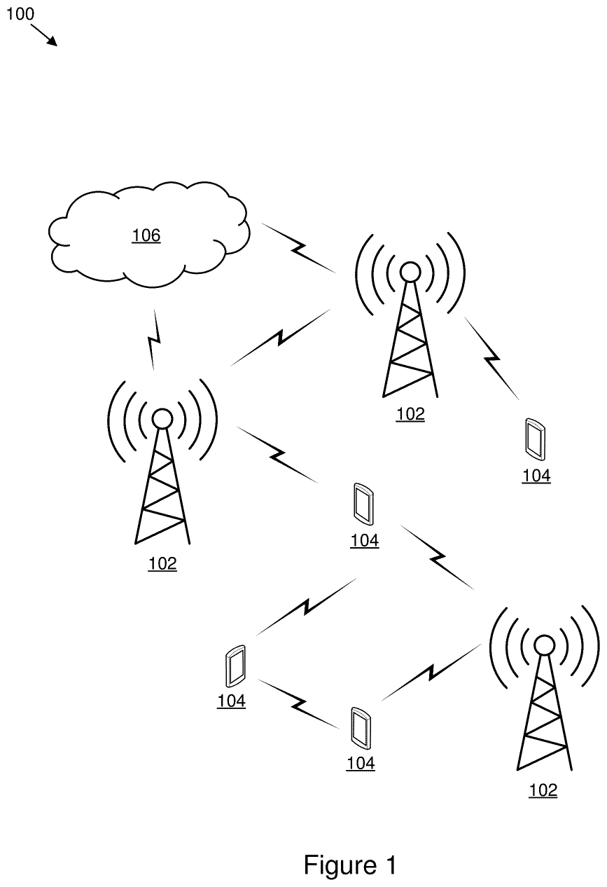

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (cNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with an NTN. In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, N3, N6 or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=2, μ=3, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2(24.25 GHZ-52.6 GHZ), FR3 (7.125 GHZ-24.25 GHZ), FR4 (52.6 GHZ-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104,among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologics). For example, FR2 may be associated with a third numerology (e.g., μ=2), which includes 60 kHz subcarrier spacing; and a fourth numerology (e.g., μ=3), which includes 120 kHz subcarrier spacing.

The wireless communication system 100 may, in some examples, be a system that supports communication on a PDCCH using CP-OFDM with fixed modulation schemes, such as QPSK. A primary consideration for efficient PDCCH transmission in such systems may be managing a PAPR and a CM of the CP-OFDM waveform. Elevated PAPR and CM values may reduce power amplifier efficiency, increase power consumption, and degrade link coverage. These effects may be particularly important for control channels, such as the PDCCH, where robust transmission and reception is critical to ensure reliable scheduling, resource allocation, and other control signaling.

SLM techniques may effectively reduce PAPR and CM by generating multiple phase-rotated candidate signals and selecting the candidate having the most favorable characteristics, such as the lowest PAPR and/or the lowest CM. However, applying SLM to a PDCCH may introduce a limitation in that a UE 104 may need to be informed of or otherwise know which phase sequence an NE 102 has selected in order to correctly demodulate and decode the PDCCH. This requirement may increase signaling overhead or decoding complexity. Various aspects described herein may enable the use of SLM for PDCCH transmission and reception while mitigating such increased signaling overhead and decoding complexity, thereby improving the practicality of SLM for control channel communication in wireless communication systems.

According to an implementation, blind decoding may be performed, for example, by a UE 104, based on a pre-configured sequence set (e.g., a sequence set stored by the UE 104 or transmitted to the UE 104). In some implementations, the UE 104 may be pre-configured with a subset of candidate phase sequences used for SLM in PDCCH transmission. At the NE 102, multiple candidate signals may be generated by applying the respective phase sequences to the QPSK-modulated PDCCH symbols. Each candidate signal may be formed by multiplying the PDCCH symbol stream by a corresponding phase sequence and then applying an inverse fast Fourier transform (IFFT). In other implementations, SLM may be applied to an entire OFDM symbol, in which the PDCCH and one or more other channels may be mapped to the same symbol. After generating the time-domain signals corresponding to the various phase sequences, the PAPR and/or CM values of each candidate signal may be computed. The candidate signal having the lowest PAPR and/or lowest CM may be selected for transmission, thereby improving power amplifier efficiency and potentially enhancing PDCCH coverage. Upon reception, the UE 104 may perform a blind decoding process, in which the received PDCCH is decoded using each of the pre-configured phase sequences until successful decoding is achieved. This process may introduce an additional layer of blind search at the UE 104 in addition to the standard PDCCH candidate monitoring procedure. However, such an approach may enable the use of SLM without requiring explicit signaling of the phase sequence selected by the NE 102.

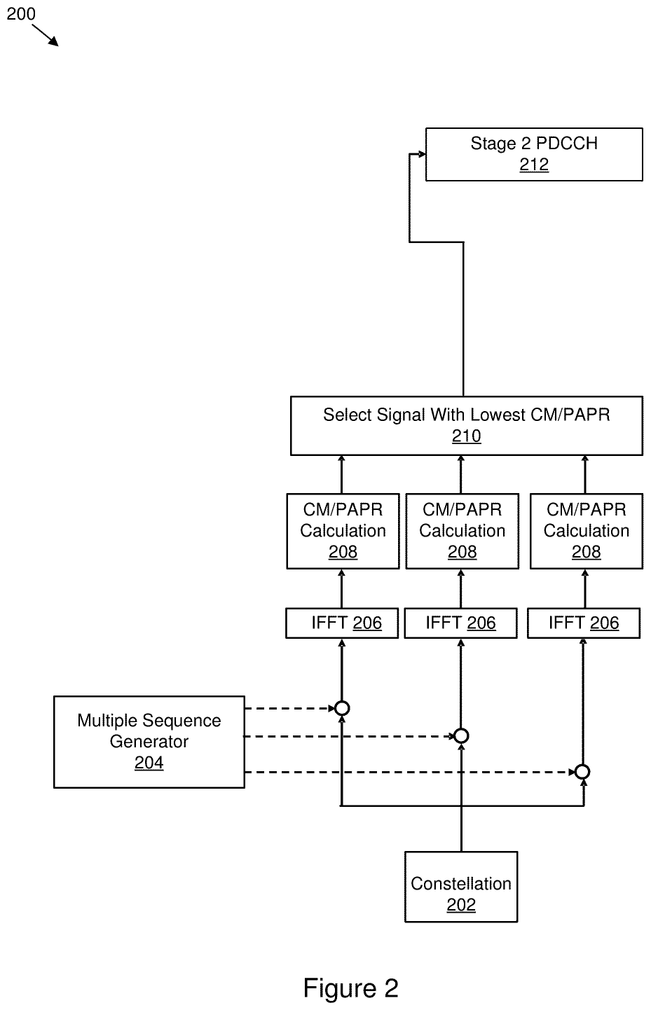

FIG. 2 illustrates an example of a functional block diagram 200 in accordance with aspects of the present disclosure. In some examples, the functional block diagram 200 implements or is implemented by aspects of the wireless communications system 100. The functional block diagram 200 may implement or be implemented by one or more devices and/or entities (e.g., network entities), including an NE 102, which may be examples of an NE 102 as described with reference to FIG. 1. For example, the functional block diagram 200 may illustrate an example of SLM-OFDM for PDCCH. Alternative examples of the following may be implemented, where some operations are performed in a different order than described or are not performed. In some cases, operations may include additional features not mentioned below, or further operations may be added.

A constellation 202 may comprise a set of constellation points, each representing a symbol that may be transmitted on a modulated carrier signal. Each constellation point may be positioned in a complex plane having an in-phase (I) axis and a quadrature (Q) axis. In some implementations, constellation points may be rotated, scaled, or otherwise transformed (e.g., via application of a phase sequence in a SLM procedure) to reduce PAPR or CM while maintaining the relative spacing between constellation points. Each modulation scheme (e.g., QPSK, QAM, and the like) may each have a corresponding constellation arrangement with a greater number of constellation points.

In the example of FIG. 2, the constellation 202, which may comprises a set of PDCCH frequency domain symbols, may be inputted (e.g., provided) to one or multiple-sequence generators 204 of the NE 102. The multiple-sequence generator 204 of the NE 102 may apply a plurality of phase sequences to the constellation 202 to produce multiple modified constellations (e.g., modified set of PDCCH frequency domain symbols). Each modified constellation is then processed by a corresponding IFFT 206 (e.g., IFFT function, IFFT block) at the NE 102 to generate a respective set of PDCCH time domain symbols. A CM and/or PAPR calculation 208 is performed at the NE 102 on each set of PDCCH time domain symbols to evaluate its transmission characteristics (e.g., PAPR values, CM values). A selection function 210 at the NE 102 identifies and selects the candidate signal having the lowest CM and/or PAPR among the generated candidates. The selected signal is then transmitted by the NE 102 as a stage-2 PDCCH 212 to the UE 104. The UE 104 receives the stage-2 PDCCH 212 and uses blind decoding to decode the stage-2 PDCCH 212.

A two-stage PDCCH transmission scheme may be supported with explicit sequence indication. This scheme may support the use of SLM while avoiding blind sequence search at the UE 104. In this approach, a first-stage PDCCH may carry auxiliary control information that may explicitly indicate the SLM phase sequence selected by the NE 102, for example, via a phase sequence index or phase sequence identifier. The second-stage PDCCH carries the downlink control information (DCI), which is modulated using the SLM-OFDM signal corresponding to the selected phase sequence.

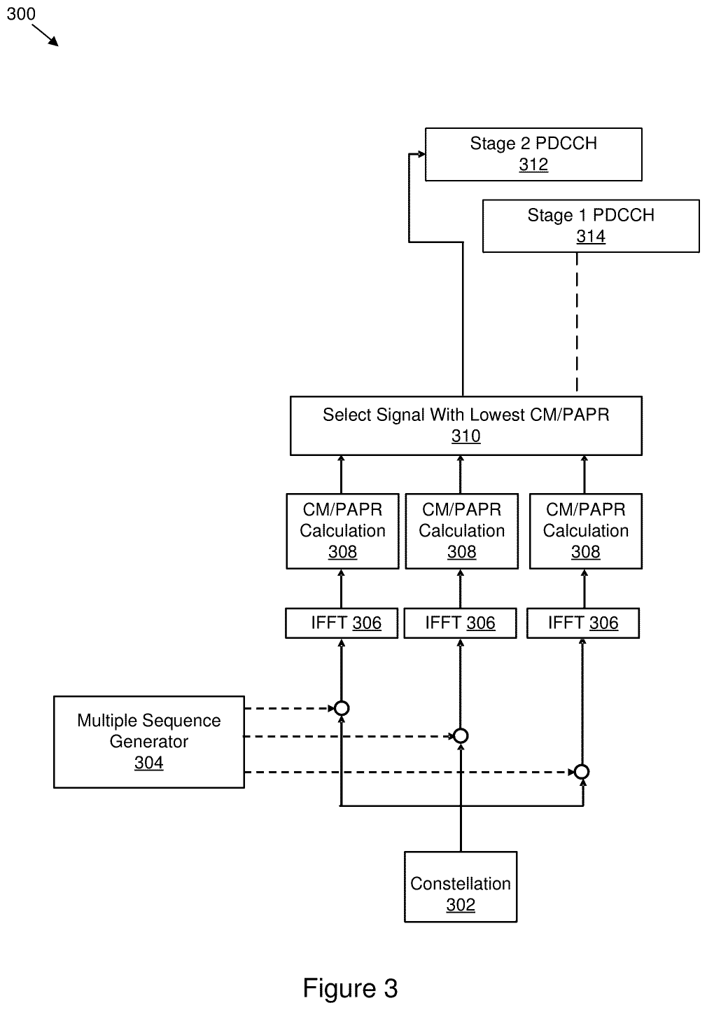

FIG. 3 illustrates an example of a functional block diagram 300 in accordance with aspects of the present disclosure. In some examples, the functional block diagram 300 implements or is implemented by aspects of the wireless communications system 100. The functional block diagram 300 may implement or be implemented by one or more devices and/or entities (e.g., network entities), including an NE 102, which may be examples of an NE 102 as described with reference to FIG. 1. For example, the functional block diagram 200 may illustrate an example of SLM-OFDM for PDCCH. Alternative examples of the following may be implemented, where some operations are performed in a different order than described or are not performed. In some cases, operations may include additional features not mentioned below, or further operations may be added.

A constellation 302 may comprise a set of constellation points, each representing a symbol that may be transmitted on a modulated carrier signal. Each constellation point may be positioned in a complex plane having an in-phase (I) axis and a quadrature (Q) axis. In some implementations, constellation points may be rotated, scaled, or otherwise transformed (e.g., via application of a phase sequence in a SLM procedure) to reduce PAPR or CM while maintaining the relative spacing between constellation points. Each modulation scheme (e.g., QPSK, QAM, and the like) may each have a corresponding constellation arrangement with a greater number of constellation points.

In the example of FIG. 3, the constellation 302, which may comprises a set of PDCCH frequency domain symbols, may be inputted (e.g., provided) to one or multiple-sequence generators 304 of the NE 102. The multiple-sequence generator 304 of the NE 102 may apply a plurality of phase sequences to the constellation 302 to produce multiple modified constellations (e.g., modified set of PDCCH frequency domain symbols). Each modified constellation is then processed by a corresponding IFFT 306 (e.g., IFFT function, IFFT block) at the NE 102 to generate a respective set of PDCCH time domain symbols. A CM and/or PAPR calculation 308 is performed at the NE 102 on each set of PDCCH time domain symbols to evaluate its transmission characteristics (e.g., PAPR values, CM values). A selection function 310 at the NE 102 identifies and selects the candidate signal having the lowest CM and/or PAPR among the generated candidates. The selected signal is then transmitted by the NE 102 as a stage-2 PDCCH 312 to the UE 104. The UE 104 receives the stage-2 PDCCH 312 and uses blind decoding to decode the stage-2 PDCCH 312.

A two-stage PDCCH transmission scheme may be supported with explicit sequence indication. This scheme may support the use of SLM while avoiding blind sequence search at the UE 104. In this approach, a stage-1 PDCCH 314 may carry auxiliary control information that may explicitly indicate the SLM phase sequence selected by the NE 102, for example, via a phase sequence index or phase sequence identifier. The stage-2 PDCCH 312 carries the downlink control information (DCI), which is modulated using the SLM-OFDM signal corresponding to the selected phase sequence.

By transmitting the SLM sequence indication in the stage-1 PDCCH 314, the UE 104 is informed in advance of the exact phase sequence used, allowing it to directly apply the correct sequence for demodulating and decoding the stage-2 PDCCH 312. This eliminates the need for blind sequence search and reduces computational complexity at the UE 104.

To enhance the reliability and coverage of the first-stage PDCCH, particularly under poor channel conditions or for cell-edge UEs 104, low-PAPR modulation or waveform schemes may be used. Examples include π/2-BPSK, Zadoff-Chu sequences, or other constant-envelope modulation schemes, which offer improved power amplifier efficiency and robustness against channel impairments.

In one implementation, a group-based sequence indication may be used with a partial blind search. In some implementations, SLM for PDCCH transmission is supported through a group-based sequence indication mechanism, which balances PAPR/CM reduction benefits with manageable UE 104 decoding complexity.

The set of available SLM phase sequences may be divided into multiple groups, each group containing a predefined number of sequences (e.g., four per group). During transmission, the NE 102 selects the sequence that yields the lowest PAPR or CM and determines the group to which the selected sequence belongs.

In the first-stage PDCCH, the NE 102 transmits only the group identifier (group ID) rather than the specific sequence index. The UE 104, having been pre-configured with knowledge of the sequence groupings, uses the group ID to limit its decoding attempts to the subset of sequences within that group.

Upon receiving the stage-1 PDCCH 314, the UE 104 performs a partial blind search, attempting to decode the stage-2 PDCCH 312—generated with SLM-OFDM—using only the sequences associated with the indicated group. This reduces the decoding burden compared to a full blind search over all possible sequences. To ensure high reliability of the first-stage signaling, particularly in poor coverage conditions, the stage-1 PDCCH 314 may be transmitted using low-PAPR modulation schemes such as π/2-BPSK, Zadoff-Chu sequences, or other constant-envelope waveforms.

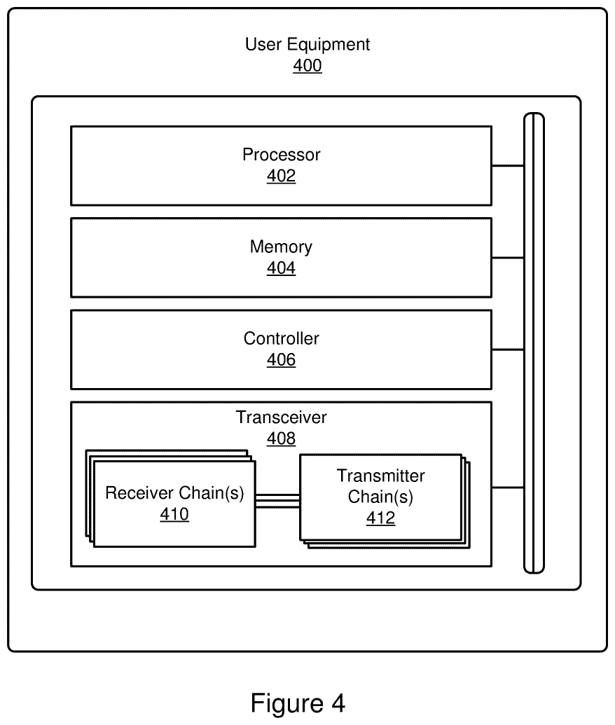

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an ASIC, or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, a field programmable gate array (FPGA), or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. In one example, the processor 402 coupled with the memory 404 is configured to cause the UE 400 to: receive a signal over a PDCCH selected from a set of signals for PDCCH in a time domain based at least in part on a criterion comprising one or more of a PAPR value satisfying a threshold, or a CM value satisfying a threshold, wherein the set of signals for PDCCH in the time domain is obtained at least in part by performing an IFFT on a modified set of symbols in a frequency domain, and the modified set of symbols is obtained by applying a phase sequence to each of one or more symbols of a set of symbols in the frequency domain; and decode the received PDCCH time-domain signal using blind decoding using phase information or signal-based sequence identification. In some implementations, the processor 402 may be further configured to: receive phase information for blind decoding the signal, wherein the phase information indicates one or more respective phase sequences applied to each of the one or more symbols of the set of symbols for PDCCH, and wherein the phase information is received statistically or semi-statistically via system information or an RRC message; receive a DCI prior to reception of the signal over PDCCH, wherein the DCI comprises one or more respective phase sequences applied to each of the one or more symbols of the set of symbols for PDCCH, and wherein the DCI is received using a low-PAPR waveform selected from one or more of: π/2-BPSK modulation, Zadoff-Chu sequences, or using repetitions; or receive an identifier corresponding to a set of phase sequences and perform partial blind decoding using only the phase sequences corresponding to the identifier, wherein the identifier is received using a waveform with a PAPR being less than or equal to a PAPR threshold value.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like PSK or QAM. The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

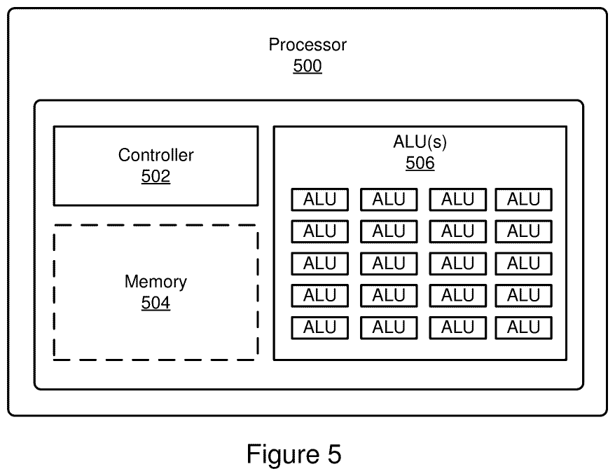

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support a means for performing various operations described herein. For example, the processor 500 may be configured to: receive a signal over a PDCCH selected from a set of signals for PDCCH in a time domain based at least in part on a criterion comprising one or more of a PAPR value satisfying a threshold, or a CM value satisfying a threshold, wherein the set of signals for PDCCH in the time domain is obtained at least in part by performing an IFFT on a modified set of symbols in a frequency domain, and the modified set of symbols is obtained by applying a phase sequence to each of one or more symbols of a set of symbols in the frequency domain; and decode the signal using blind decoding using phase information or signal-based sequence identification. In some implementations, the processor 500 may be further configured to: receive phase information for blind decoding the signal, wherein the phase information indicates one or more respective phase sequences applied to each of the one or more symbols of the set of symbols for PDCCH, and wherein the phase information is received statistically or semi-statistically via system information or an RRC message; receive a DCI prior to reception of the signal over PDCCH, wherein the DCI comprises one or more respective phase sequences applied to each of the one or more symbols of the set of symbols for PDCCH, and wherein the DCI is received using a low-PAPR waveform selected from one or more of: π/2-BPSK modulation, Zadoff-Chu sequences, or using repetitions; or receive an identifier corresponding to a set of phase sequences and perform partial blind decoding using only the phase sequences corresponding to the identifier, wherein the identifier is received using a waveform with a PAPR being less than or equal to a PAPR threshold value.

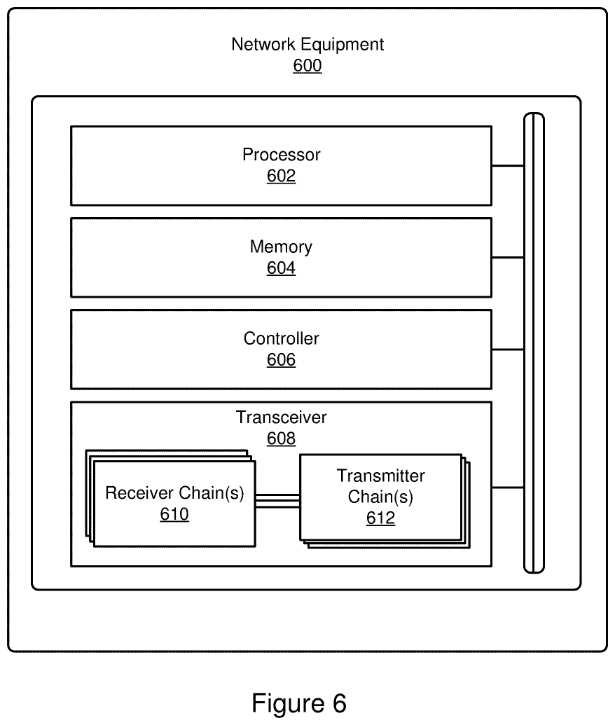

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an ASIC, or other programmable logic device, or any combination thereof configured as or otherwise supporting a means for performing the functions described in the present disclosure.

The processor 602 may include an intelligent hardware device. In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure. For example, the processor 602 coupled with the memory 604 may be configured to cause the NE 600 to: modify a set of symbols in a frequency domain based at least in part on applying a phase sequence to each of one or more symbols of the set of symbols for PDCCH; obtain a set of signals for PDCCH in a time domain based at least in part on performing an IFFT on the modified set of symbols in the frequency domain; select a signal from the set of signals for PDCCH in the time domain based at least in part on a criterion comprising one or more of a PAPR value satisfying a threshold, or a CM value satisfying a threshold; and transmit the selected signal over PDCCH to a UE, wherein the selected signal is decodable using blind decoding using phase information or signal-based sequence identification. In some implementations, the processor 602 may be further configured to: transmit phase information for blind decoding the signal, wherein the phase information indicates one or more respective phase sequences applied to each of the one or more symbols of the set of symbols for PDCCH, and wherein the phase information is transmitted statistically or semi-statistically via system information or an RRC message; transmit a DCI prior to transmission of the signal over PDCCH, wherein the DCI comprises one or more respective phase sequences applied to each of the one or more symbols of the set of symbols for PDCCH, and wherein the DCI is transmitted using a low-PAPR waveform selected from one or more of: π/2-BPSK modulation, Zadoff-Chu sequences, or using repetitions; or transmit an identifier corresponding to a set of phase sequences and configure the UE to perform partial blind decoding using only the phase sequences corresponding to the identifier, wherein the identifier is transmitted using a waveform with a PAPR being less than or equal to a PAPR threshold value.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

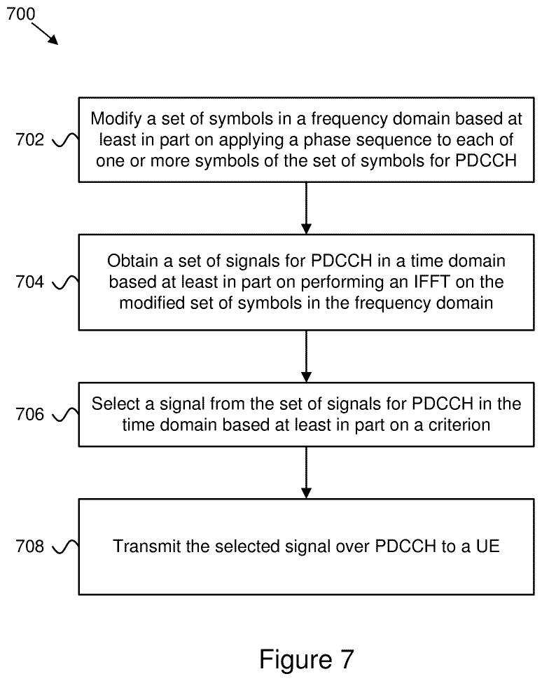

FIG. 7 illustrates a flowchart of a method 700 in accordance with aspects of the present disclosure. The operations of the method 700 may be implemented by an NE. In some implementations, the NE may execute a set of instructions to control the function elements of a processor to perform the described functions. It should be noted that the method described herein describes a possible implementation, and that the operations and the steps may be rearranged or otherwise modified and that other implementations are possible.

At 702, the method may include modifying, by a base station, a set of symbols in a frequency domain based at least in part on applying a phase sequence to each of one or more symbols of the set of symbols for PDCCH to result in a modified set of symbols in the frequency domain. The operations of 702 may be performed in accordance with examples described herein, and in some implementations, aspects of the operations of 702 may be performed by an NE as described with reference to FIG. 6.

At 704, the method may include obtaining, by the base station, a set of signals for PDCCH in a time domain based at least in part on performing an IFFT on the modified set of symbols in the frequency domain, and selecting a signal from the set of signals for PDCCH in the time domain based at least in part on a criterion comprising one or more of a PAPR value satisfying a threshold, or a CM value satisfying a threshold. The operations of 704 may be performed in accordance with examples described herein. In some implementations, aspects of the operations of 704 may be performed by an NE as described with reference to FIG. 6.

At 706, the method may include transmitting, to a UE, the selected signal over PDCCH, wherein the selected signal is decodable using blind decoding using phase information or signal-based sequence identification. In some implementations, the method may further include transmitting phase information for blind decoding the signal, wherein the phase information indicates one or more respective phase sequences applied to each of the one or more symbols of the set of symbols for PDCCH, and wherein the phase information is transmitted statistically or semi-statistically via system information or an RRC message. In another implementation, the method may further include transmitting, prior to transmitting the selected signal over PDCCH, a DCI indicating one or more respective phase sequences applied to each of the one or more symbols of the set of symbols for PDCCH, wherein the DCI is transmitted using a low-PAPR waveform selected from one or more of: π/2-BPSK modulation, Zadoff-Chu sequences, or using repetitions.

At 708, the method may include transmitting the selected signal over PDCCH to a UE, wherein the selected signal is decodable using blind decoding using phase information or signal-based sequence identification. In yet another implementation, the method may further include grouping the phase sequences into multiple phase sequence groups, transmitting an identifier corresponding to a group containing the phase sequences, and configuring the UE to perform partial blind decoding using only the phase sequences corresponding to the identifier, wherein the identifier is transmitted using a waveform with a PAPR being less than or equal to a PAPR threshold value. The operations of 708 may be performed in accordance with examples described herein. In some implementations, aspects of the operations of 708 may be performed by an NE as described with reference to FIG. 6.

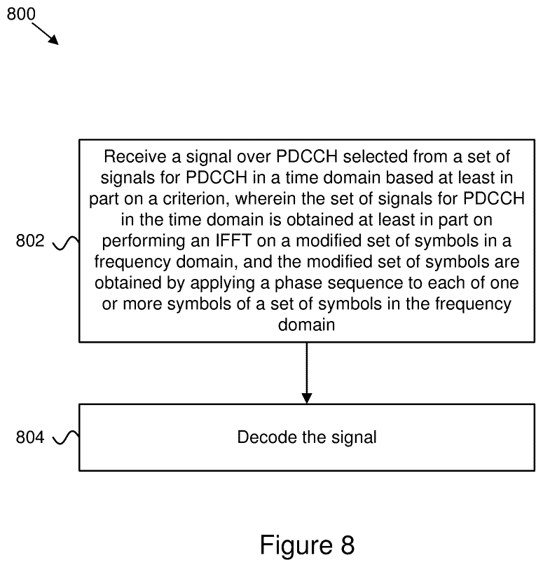

FIG. 8 illustrates a flowchart of a method 800 in accordance with aspects of the present disclosure. The operations of the method 800 may be implemented by a UE as described herein. In some implementations, the UE may execute a set of instructions to control the function elements of a processor to perform the described functions. It should be noted that the method described herein describes a possible implementation, and that the operations and the steps may be rearranged or otherwise modified and that other implementations are possible.

At 802, the method may include receiving, by a UE, a signal over a PDCCH selected from a set of signals for PDCCH in a time domain based at least in part on a criterion comprising one or more of a PAPR value satisfying a threshold, or a CM value satisfying a threshold. The set of signals for PDCCH in the time domain may be obtained at least in part by performing an IFFT on a modified set of symbols in a frequency domain, wherein the modified set of symbols is obtained by applying a phase sequence to each of one or more symbols of a set of symbols in the frequency domain. The operations of 802 may be performed in accordance with examples described herein. In some implementations, aspects of the operations of 802 may be performed by a UE as described with reference to FIG. 4.

At 804, the method may include decoding the received signal using blind decoding using phase information or signal-based sequence identification. In some implementations, the method may further include receiving phase information for blind decoding the signal, wherein the phase information indicates one or more respective phase sequences applied to each of the one or more symbols of the set of symbols for PDCCH, and wherein the phase information is received statistically or semi-statistically via system information or an RRC message. In another implementation, the method may further include receiving, prior to receiving the signal over PDCCH, a DCI comprising one or more respective phase sequences applied to each of the one or more symbols of the set of symbols for PDCCH, wherein the DCI is received using a low-PAPR waveform selected from one or more of: π/2-BPSK modulation, Zadoff-Chu sequences, or using repetitions. In yet another implementation, the method may further include receiving an identifier corresponding to a set of phase sequences and performing partial blind decoding using only the phase sequences corresponding to the identifier, wherein the identifier is received using a waveform with a PAPR being less than or equal to a PAPR threshold value. The operations of 804 may be performed in accordance with examples described herein. In some implementations, aspects of the operations of 804 may be performed by a UE as described with reference to FIG. 4.

It should be noted that the methods described herein describe possible implementations, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station, comprising:
at least one memory; and
at least one processor coupled with the at least one memory and configured to cause the base station to:
modify a set of symbols in a frequency domain based at least in part on applying a phase sequence to each of one or more symbols of the set of symbols for physical downlink control channel (PDCCH);
obtain a set of signals for PDCCH in a time domain based at least in part on performing an inverse fast Fourier transform (IFFT) on the modified set of symbols in the frequency domain;
select a signal from the set of signals for PDCCH in the time domain based at least in part on a criterion; and
transmit the selected signal over PDCCH to a user equipment (UE).

2. The base station of claim 1, wherein the criterion comprises one or more of a peak-to-average power ratio (PAPR) value satisfying a threshold, or cubic metric (CM) value satisfying a threshold.

3. The base station of claim 1, wherein the at least one processor is configured to cause the base station to transmit phase information for blind decoding the transmitted signal over the PDCCH, wherein the phase information indicates one or more respective phase sequences applied to each of the one or more symbols of the set of symbols for PDCCH.

4. The base station of claim 3, wherein the phase information is transmitted via system information (SI) or a radio resource control (RRC) message.

5. The base station of claim 1, wherein the at least one processor is configured to cause the base station to transmit a downlink control information (DCI) prior to transmission of the selected signal over PDCCH, wherein the DCI comprises one or more respective phase sequences applied to each of the one or more symbols of the set of symbols for PDCCH.

6. The base station of claim 5, wherein the DCI is transmitted using a low peak-to-average power ratio (PAPR) waveform selected from one or more of: w/2-binary phase shift keying (BPSK) modulation, Zadoff-Chu sequences, or using repetitions.

7. The base station of claim 1, wherein the at least one processor is configured to cause the base station to:
modify the set of symbols in the frequency domain based at least in part on applying a set of phase sequences to the set of symbols for PDCCH;
transmit an identifier corresponding to the set of phase sequences; and
transmit information indicating to perform partial blind decoding using phase sequences of the set of phase sequences corresponding to the identifier.

8. The base station of claim 7, wherein the identifier is transmitted using a waveform with a peak-to-average power ratio (PAPR) being less than or equal to a PAPR threshold value.

9. A method performed by a base station, the method comprising:
modifying a set of symbols in a frequency domain based at least in part on applying a phase sequence to each of one or more symbols of the set of symbols for physical downlink control channel (PDCCH);
obtaining a set of signals for PDCCH in a time domain based at least in part on performing an inverse fast Fourier transform (IFFT) on the modified set of symbols in the frequency domain;
selecting a signal from the set of signals for PDCCH in the time domain based at least in part on a criterion; and
transmitting the selected signal over PDCCH to a user equipment (UE).

10. A user equipment (UE), comprising:
at least one memory; and
at least one processor coupled with the at least one memory and configured to cause the UE to:
receive a signal over physical downlink control channel (PDCCH) selected from a set of signals for PDCCH in a time domain based at least in part on a criterion, wherein the set of signals for PDCCH in the time domain is obtained at least in part on performing an inverse fast Fourier transform (IFFT) on a modified set of symbols in a frequency domain, and the modified set of symbols are obtained by applying a phase sequence to each of one or more symbols of a set of symbols in the frequency domain; and
decode the signal.

11. The UE of claim 10, wherein the criterion comprises one or more of a peak-to-average power ratio (PAPR) value satisfying a threshold, or cubic metric (CM) value satisfying a threshold.

12. The UE of claim 10, wherein the at least one processor is configured to cause the UE to receive phase information for blind decoding the received signal over the PDCCH, wherein the phase information indicates one or more respective phase sequences applied to each of the one or more symbols of the set of symbols for PDCCH.

13. The UE of claim 12, wherein the phase information is transmitted via system information (SI) or a radio resource control (RRC) message.

14. The UE of claim 10, wherein the at least one processor is configured to cause the UE to receive a downlink control information (DCI) prior to reception of the signal over PDCCH, wherein the DCI comprises one or more respective phase sequences applied to each of the one or more symbols of the set of symbols for PDCCH.

15. The UE of claim 14, wherein the DCI is transmitted using a low peak-to-average power ratio (PAPR) waveform selected from one or more of: π/2-binary phase shift keying (BPSK) modulation, Zadoff-Chu sequences, or using repetitions.

16. The UE of claim 10, wherein the at least one processor is configured to cause the UE to:
receive an identifier corresponding to the set of phase sequences; and
perform partial blind decoding using phase sequences of the set of phase sequences corresponding to the identifier.

17. The UE of claim 16, wherein the identifier is receiving using a waveform with a peak-to-average power ratio (PAPR) being less than or equal to a PAPR threshold value.

18. A method performed by a user equipment (UE), the method comprising:
receiving a signal over physical downlink control channel (PDCCH) selected from a set of signals for PDCCH in a time domain based at least in part on a criterion, wherein the set of signals for PDCCH in the time domain is obtained at least in part on performing an inverse fast Fourier transform (IFFT) on a modified set of symbols in a frequency domain, and the modified set of symbols are obtained by applying a phase sequence to each of one or more symbols of a set of symbols in the frequency domain; and
decoding the signal.

19. The method of claim 18, wherein the criterion comprises one or more of a peak-to-average power ratio (PAPR) value satisfying a threshold, or cubic metric (CM) value satisfying a threshold.

20. The method of claim 18, further comprising receiving phase information for blind decoding the received signal over the PDCCH, wherein the phase information indicates one or more respective phase sequences applied to each of the one or more symbols of the set of symbols for PDCCH.
